(19) United States
(12) Patent Application Publication
(10) Pub. No.: US 2026/0079373 A1
(43) Pub. Date: Mar. 19, 2026

(54) ARRAY SUBSTRATES AND DISPLAY PANELS

(71) Applicant: TCL CHINA STAR OPTOELECTRONICS TECHNOLOGY CO., LTD., Shenzhen (CN)

(72) Inventors: Jing LIU, Shenzhen (CN); Shengqiang OUYANG, Shenzhen (CN); Yulu ZHANG, Shenzhen (CN); Peng DU, Shenzhen (CN)

(73) Assignee: TCL CHINA STAR OPTOELECTRONICS TECHNOLOGY CO., LTD., Shenzhen (CN)

(21) Appl. No.: 18/948,423

(22) Filed: Nov. 14, 2024

(30) Foreign Application Priority Data
Sep. 14, 2024 (CN) 202411296872.7

(51) Int. Cl. G02F 1/1368; G02F 1/1343; G02F 1/1362

(52) U.S. Cl. CPC G02F 1/1368; G02F 1/134318; G02F 1/136286

(57) ABSTRACT

Array substrates and display panels are provided in the present application provides. By the gradually decreased width of at least one portion of the branch electrodes in the array substrate along the direction from a position near a connection between the branch electrodes and the main electrode to a position away from the connection between the branch electrodes and the main electrodes, at least one region having different electric field intensities at various positions thereof is presented in the array substrate, which therefore causes the deflection angle of the liquid crystal distinctive at various positions of the at least one region. Consequently, a viewing angle effect from 8-domain can be achieved based on a 4-domain design, providing a display effect with a wide viewing angle at a low gray scale and a high transmittance at a high gray scale and compromising the wide viewing angle with a high aperture ratio.

### CROSS-REFERENCE TO RELATED APPLICATION

The present application claims priority to and the benefit of Chinese Patent Application No. 202411296872.7, filed on Sep. 14, 2024, the disclosure of which is incorporated herein by reference in its entirety.

### TECHNICAL FIELD

The present application relates to a field of display, and in particular, to array substrates and display panels.

### BACKGROUND

Types of liquid crystal display (LCD) devices include twisted nematic (TN) or super twisted nematic (STN), in-plane switching (IPS), and vertical alignment (VA). Among these, VA LCDs are widely used due to their extremely high contrast ratio compared to other types of LCDs. An 8-domain design is employed in current VA LCD devices to increase a viewing angle. This is achieved by dividing the sub-pixels into main-regions and sub-regions and shared electrodes or common wirings are used to perform voltage division on the sub-regions, thus achieving a wide viewing angle display. However, this design results in a lower aperture ratio, and during liquid crystal displays are displayed in a high gray scale, the sub-regions are insufficiently charged, leading to relatively low transmittance. Conversely, in a 4-domain design, although the aperture ratio and transmittance are relatively high, the viewing angle is relatively small because the 4-domain design is controlled by only one transistor without the need to partitioned activation.

Therefore, the existing VA Liquid Crystal Display devices are faced a technical problem of being unable to simultaneously achieve a wide viewing angle and a high aperture ratio.

### SUMMARY

Embodiments of the present application provide array substrates and display panels to solve a technical issue of an inability to balance wide viewing angles and high aperture ratios in existing VA liquid crystal display devices.

An embodiment of the present application provides an array substrate, comprising:
a substrate;
a gate electrode layer disposed on a side of the substrate;
a source-drain electrode layer disposed on a side of the gate electrode layer away from the substrate; and

a pixel electrode layer disposed on a side of the source-drain electrode layer away from the gate electrode layer, wherein the pixel electrode layer comprises a pixel electrode, which comprises a main electrode, branch electrodes, and slits, and the main electrode comprises a first main electrode aligned along a first direction and a second main electrode aligned along a second direction;
wherein at least one portion of the branch electrodes has a gradually decreased width along a direction from a position near a connection between the branch electrodes and the main electrodes to a position away from the connection between the branch electrodes and the main electrodes.

Correspondingly, an embodiment of the present application also provides a display panel, comprising an array substrate, the array substrate comprising:
a substrate;
a gate electrode layer disposed on a side of the substrate;
a source-drain electrode layer disposed on a side of the gate electrode layer away from the substrate; and
a pixel electrode layer disposed on a side of the source-drain electrode layer away from the gate electrode layer, wherein the pixel electrode layer comprises a pixel electrode, which comprises a main electrode, branch electrodes, and slits, and the main electrode comprises a first main electrode aligned along a first direction and a second main electrode aligned along a second direction;
wherein at least one portion of the branch electrodes has a gradually decreased width along a direction from a position near a connection between the branch electrodes and the main electrodes to a position away from the connection between the branch electrodes and the main electrodes.

An array substrate and a display panel are provided in the present application, by the gradually decreased width of at least one portion of the branch electrodes in the array substrate along the direction from a position near a connection between the branch electrodes and the main electrode to a position away from the connection between the branch electrodes and the main electrodes, at least one region having different electric field intensities at various positions thereof is presented in the array substrate, which therefore causes the deflection angle of the liquid crystal distinctive at various positions of the at least one region. Consequently, a viewing angle effect from 8-domain can be achieved based on a 4-domain design, providing a display effect with a wide viewing angle at a low gray scale and a high transmittance at a high gray scale. This approach compromises the wide viewing angle with a high aperture ratio.

### BRIEF DESCRIPTION OF THE DRAWINGS

A detailed description of specific embodiments of the present application is provided in conjunction with the accompanying drawings below, making the technical solutions and other beneficial effects of the present application apparent.

FIG. 1 is a schematic diagram of a comparative display device provided in an embodiment of the present application.

FIG. 2 is a schematic diagram of an array substrate provided in an embodiment of the present application.

FIG. 3 is a first stacking diagram of various film layers of the array substrate provided in an embodiment of the present application.

FIG. 4 is a cross-sectional schematic diagram of the array substrate in FIG. 3.

FIG. 5 is a second stacking diagram of various film layers of the array substrate provided in an embodiment of the present application.

FIG. 6 is a third stacking diagram of various film layers of the array substrate provided in an embodiment of the present application.

FIG. 7 is an exploded view of various film layers of the array substrate in FIG. 3.

### DETAILED DESCRIPTION

The following sections will clearly and comprehensively describe the technical solutions presented in the embodiments of the present application, in conjunction with the accompanying drawings. It is evident that the described embodiments represent only a portion of the possible embodiments, but not all of them. Any other embodiments derived by those skilled in the art, without requiring inventive effort, are considered to fall within the scope of the present application.

In the description of the present application, it should be understood that terms such as “center”, “longitudinal”, “transverse”, “length”, “width”, “thickness”, “upper”, “lower”, “front”, “rear”, “left”, “right”, “vertical”, “horizontal”, “top”, “bottom”, “inner”, “outer”, “clockwise”, “counterclockwise”, etc., indicating orientations or positional relationships, are based on the orientations or positional relationships shown in the drawings. These terms are used merely for the convenience of description of the present application and simplifying the description and are not intended to indicate or imply that referenced devices or elements must have specific orientations or be constructed and operated in specific orientations. Therefore, they should not be construed as limiting the present application. Furthermore, the terms “first” and “second” are used solely for descriptive purposes and should not be understood as indicating or implying relative importance or implicitly defining the number of referenced technical features. Thus, features defined as “first” and “second” may explicitly or implicitly include one or more of the described features. In the description of the present application, the term “multiple” refers to two or more unless otherwise specifically defined.

In the description of the present application, it should be noted that unless otherwise explicitly specified and defined, the terms “installation”, “connected”, and “connection” should be broadly interpreted. For example, it can be a fixed connection, a detachable connection, or an integral connection; it can be a mechanical connection, an electrical connection, or a communicative connection; it can be a direct connection or an indirect connection through an intermediary medium; it can be an internal communication between two elements or an interaction relationship between two elements. For those skilled in the art, the specific meanings of the above terms in the present application can be understood according to the specific circumstances.

In the present application, unless explicitly specified and limited, a first feature being located “above” or “below” a second feature may refer to the first feature and second feature being in direct contact, or may refer to the first feature and second feature not being in direct contact but being in contact through other features situated between them. Additionally, the first feature being located “above”, “over”, and “on top of” the second feature may refer to the first feature being directly or diagonally above the second feature, or merely indicate that the first feature is at a higher horizontal level than the second feature. Similarly, the first feature being located “below”, “under”, and “beneath” the second feature may refer to the first feature being directly or diagonally below the second feature, or merely indicate that the first feature is at a lower horizontal level than the second feature.

The disclosure below provides numerous different embodiments or examples for implementing various structures described in the present application. To simplify the disclosure, the components and settings of specific examples are described below. Of course, these are merely examples and are not intended to limit the application. Additionally, the present application may repeat reference numerals and/or reference letters in different examples. Such repetition is for simplification and clarity and does not indicate a relationship between the various embodiments and/or configurations discussed. Furthermore, while specific processes and materials are provided as examples in the present application, one of ordinary skill in the art will recognize applicability of other processes and/or uses of other materials.

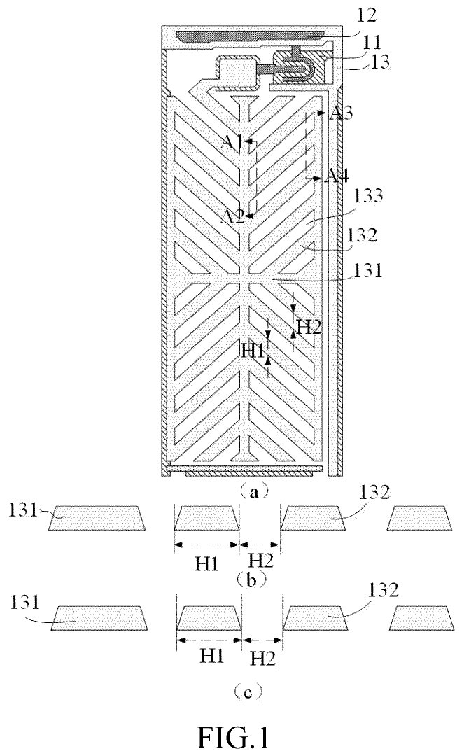

As shown in FIG. 1, FIG. 1(a) is a stacking diagram of various film layers in a pixel structure of a comparative display device, FIG. 1(b) is a cross-sectional schematic diagram along an A1-A2 line in FIG. 1(a), and FIG. 1(c) is a cross-sectional schematic diagram along an A3-A4 line in FIG. 1(a). To illustrate the principle behind the technical problem to be addressed by the present application, a comparative display device is provided, which cannot be deemed as an existing display device in the field. As shown in FIG. 1, the comparative display device includes a gate film 11, a source-drain film 12, and a pixel electrode film 13. The pixel electrode film 13 comprises a main trunk 131, branches 132, and gaps 133. In the comparative display device, each branch 132 has an equal longitudinal length H1, and each gap 133 between the branches has an equal longitudinal length H2. As shown in (b) and (c) of FIG. 1, the branches 132 at different positions have a longitudinal length of H1 respectively, and the gaps 133 at different positions have a longitudinal length of H2 respectively. Additionally, only one transistor is disposed in a sub-pixel. Thus, the liquid crystal deflection angle in each region of the sub-pixel is the same, making it impossible to achieve partition control, resulting in a smaller viewing angle. Although an 8-domain design can achieve partition control, multiple TFTs and multiple wirings to achieve partition control are required, resulting in a lower aperture ratio. Therefore, existing VA liquid crystal display devices are faced the technical problem of not being able to compromise a wide viewing angle with a high aperture ratio.

To solve the aforementioned issues, an array substrate and a display panel are provided in the present application.

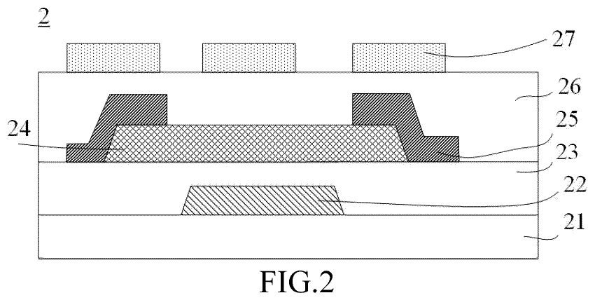

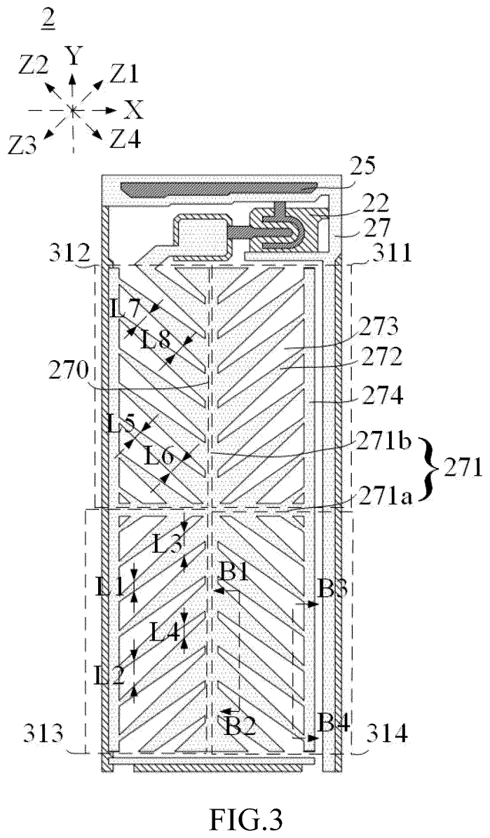

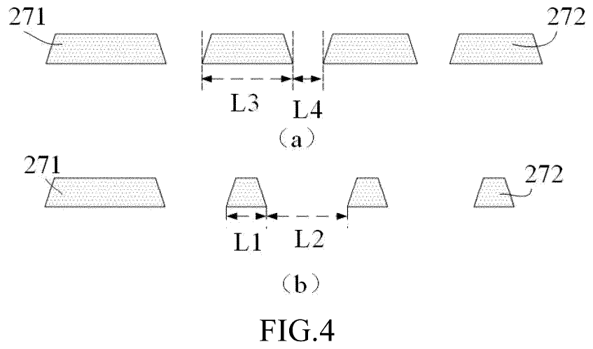

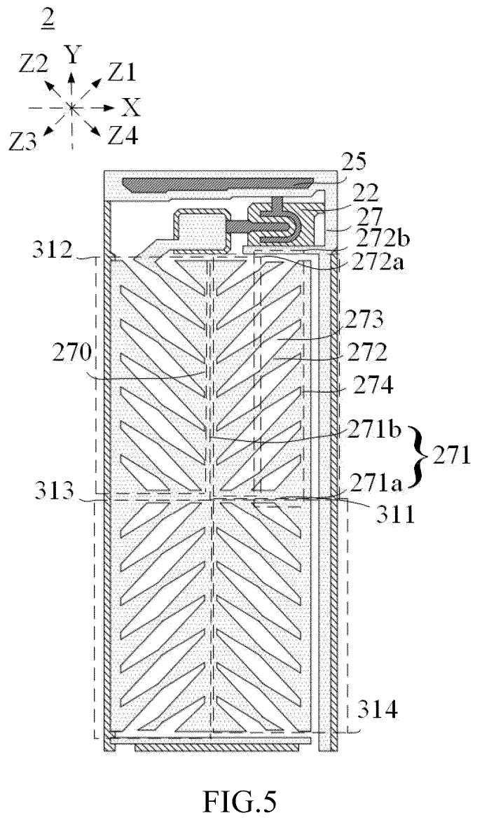

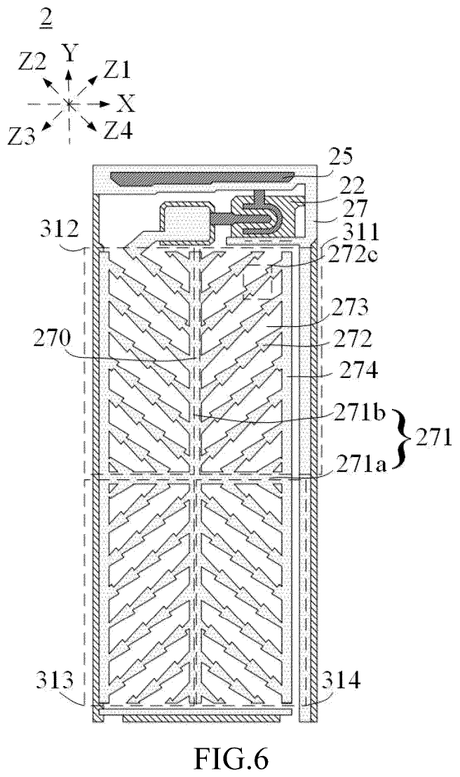

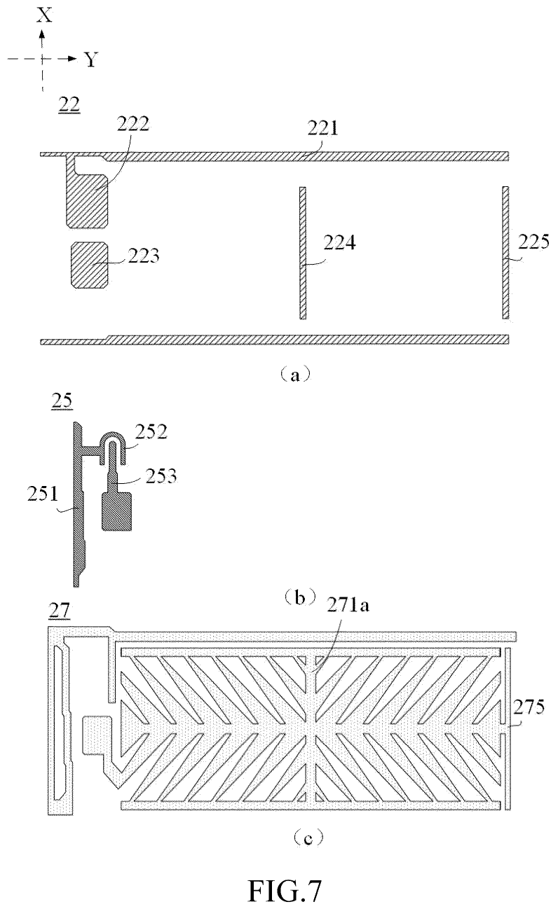

FIG. 2 is a schematic diagram of an array substrate provided in an embodiment of the present application. FIG. 3 is a first stacking diagram of various film layers of the array substrate provided in an embodiment of the present application. FIG. 4 is a cross-sectional schematic diagram of the array substrate in FIG. 3. FIG. 4(a) shows a cross-sectional view along a B1-B2 line of the array substrate in FIG. 3. FIG. 4(b) shows a cross-sectional view along a B3-B4 line of the array substrate in FIG. 3. FIG. 5 illustrates the second stacking diagram of various film layers of the array substrate in an embodiment. FIG. 6 presents the third stacking diagram of various film layers of the array substrate in an embodiment. FIG. 7 provides an exploded view of various film layers of the array substrate shown in FIG. 3. Specifically, FIG. 7(a) is an exploded view of the gate electrode layer, FIG. 7(b) is an exploded view of the source-drain electrode layer, and FIG. 7(c) is an exploded view of the pixel electrode layer.

As shown in FIG. 2 to FIG. 4, an embodiment of the present application provides an array substrate. The array substrate 2 includes a substrate 21, a gate electrode layer 22, a source-drain electrode layer 25, and a pixel electrode layer 27. The gate electrode layer 22 is disposed on a side of the substrate 21, the source-drain electrode layer 25 is disposed on a side of the gate electrode layer 22 that is away from the substrate 21, and the pixel electrode layer 27 is disposed a the side of the source-drain electrode layer 25 that is away from the gate electrode layer 22. The pixel electrode layer 27 includes a pixel electrode 270, which comprises a main electrode 271, branch electrodes 272, and slits 273. The main electrode 271 includes a first main electrode 271a arranged in a first direction X and a second main electrode 271b arranged in a second direction Y.

In the first direction X, the width of one portion of the branch electrode 272 is greater than the width of another portion of the branch electrode 272. Additionally, the width of the slit 273 corresponding to one portion of the branch electrode 272 is smaller than the width of the slit corresponding to another portion of the branch electrode 272 (for example, the width L6 of one portion of the branch electrode 272 in FIG. 3 is greater than the width L5 of another portion of the branch electrode 272, and the width L8 of the slit corresponding to one portion of the branch electrode is smaller than the width L7 of the slit corresponding to another portion of the branch electrode).

An array substrate is provided in the present application. The array substrate achieves at least two regions with different electric field intensities by making the width of one portion of the branch electrode greater than the width of another portion of the branch electrode in the first direction, and making the width of the slit corresponding to one portion of the branch electrode smaller than the width of the slit corresponding to another portion of the branch electrode. Consequently, the liquid crystal deflection angles in the regions with different electric field intensities vary, enabling an 8-domain viewing angle effect based on a 4-domain design. This results in a wide viewing angle at a low gray scale and also a high transmittance at a high gray scale, thereby compromise a wide viewing angle with a high aperture ratio.

In some embodiments, as shown in FIG. 3, FIG. 5, and FIG. 6, at least one portion of the branch electrodes 272 has a gradually decreased width along a direction from a position near a connection between the branch electrodes 272 and the main electrode 271 to a position away from the connection between the branch electrodes and the main electrodes. By the gradually decreased width of at least one portion of the branch electrodes in this direction, at least one region having different electric field intensities at various positions thereof is presented in the array substrate, which therefore causes the deflection angle of the liquid crystal distinctive at various positions of the at least one region. Consequently, a viewing angle effect from 8-domain can be achieved based on a 4-domain design, providing a display effect with a wide viewing angle at a low gray scale and a high transmittance at a high gray scale. This approach compromises the wide viewing angle with a high aperture ratio.

Specifically, the slit can be understood as a gap located between two adjacent branch electrodes or between a branch electrode and a main electrode. Except for the branch electrodes in the edge region, which may have a slit on only one side, the branch electrodes in other regions have slits on both sides. Therefore, when the branch electrode is in the edge region, the slit corresponding to one portion of the branch electrode can refer to the slit on one side of the one portion of the branch electrode. When the branch electrode is in the middle region, the slit corresponding to one portion of the branch electrode can refer to the slits on both sides of the one portion of the branch electrode. It is understood that the widths of the slits on both sides of the one portion of the branch electrode can be equal. Furthermore, the slit corresponding to one portion of the branch electrode refers to the gap between the one portion of the branch electrode and other branch electrodes. For example, the slits corresponding to one portion of the branch electrode with a width of L6 are the slits on both sides of the one portion, and the width of the slits corresponding to one portion of the branch electrode with a width of L6 is L8. Similarly, the slits of corresponding to another portion of the branch electrode with a width of L5 are the slits on both sides of the another portion, and the width of the slits corresponding to another portion of the branch electrode with a width of L5 is L7. That means that the relatively small width of one portion of the branch electrode and the relatively large width of the slits corresponding to the portion of the branch electrode can avoid an increased space occupied by a single pixel and improve pixel density.

Specifically, as shown in FIG. 1 and FIG. 4, in the embodiment of the present application, the length L3 of one portion of the branch electrode 272 in the second direction Y is greater than the length L1 of another portion of the same branch electrode in the second direction Y. Correspondingly, the spacing L4 between some portions of adjacent branch electrodes 272 is less than the spacing L2 between other portions of adjacent branch electrodes 272. This results in the electric field intensity in the region of the branch electrode with length L3 being greater than that in the region of the branch electrode with length L1. Consequently, during display, the liquid crystal deflection angle in the region of the portion of the branch electrode with length L3 differs from the deflection angle in the region of the portion of the branch electrode with length L1, which achieves different liquid crystal deflection angles in different regions of a sub-pixel unit, thereby improving the viewing angle. Additionally, the adopted 4-domain structure can increase aperture ratio.

Specifically, it can be understood that, without changing the occupied area of the pixel electrode, the increased width of the branch electrode will necessarily reduce the width of the slit, ensuring that the sum of the two remains unchanged and the total width of the pixel electrode remains unchanged. Furthermore, by ensuring that the width of each branch electrode along a straight line in the second direction Y is equal, as shown in FIG. 4(a) and FIG. 4(b), the sum of the length L3 of one portion of the branch electrode 272 in the second direction Y and the spacing L4 between some portions of the adjacent branch electrodes 272 is equal to the sum of the length L1 of another portion of the branch electrode 272 in the second direction Y and the spacing L2 between other portions of the adjacent branch electrodes 272.

In some embodiments, the array substrate includes multiple sub-pixel units, each sub-pixel unit comprising four domains.

In some embodiments, as illustrated in FIG. 3, in the first direction X, the width of the portion of the branch electrode 272 near the second main electrode 271b is greater than the width of the portion of the branch electrode 272 away from the second main electrode 271b. Additionally, the width of the slit 273 corresponding to the portion of the branch electrode 272 near the second main electrode 271b is less than the width of the slit 273 corresponding to the portion of the branch electrode 272 away from the second main electrode 271b. For instance, the width L6 of the portion of the branch electrode 272 near the second main electrode 271b is greater than the width L5 of the portion of the branch electrode 272 away from the second main electrode 271b. The width L8 of the slit corresponding to the portion of the branch electrode 272 near the second main electrode 271b is less than the width L7 of the slit corresponding to the portion of the branch electrode 272 away from the second main electrode 271b. By designing the width of the portion of the branch electrode near the second main electrode to be relatively great and the width of the slit corresponding the portion of the branch electrode near the second main electrode to be relatively small, the electric field intensity near the second main electrode in the array substrate can be greater compared to the area away from the second main electrode. This results in different liquid crystal deflection angles, achieving an effect of a wide viewing angle, with the region near the second main electrode lighting up first.

Specifically, in the described embodiment above, the width of the portion of the branch electrode near the second main electrode is greater than the width of the portion away from the second main electrode. The width of the slit corresponding to the portion of the branch electrode near the second main electrode is smaller than the width of the slit corresponding to the portion of the branch electrode away from the second main electrode. However, the embodiments of the present application are not limited to this configuration. The width of the portion of the branch electrode near the second main electrode could be smaller than the width of the portion of the branch electrode away from the second main electrode, with the width of the slit corresponding to the portion of the branch electrode near the second main electrode being greater than the width of the slit corresponding to the portion of the branch electrode away from the second main electrode.

In some embodiments, as illustrated in FIG. 3, the sum of the width of the portion of the branch electrode 272 near the second main electrode 271b and the width of the slit 273 corresponding to the portion of the branch electrode 272 near the second main electrode 271b is equal to the sum of the width of the portion of the branch electrode 272 away from the second main electrode 271b and the width of the slit 273 corresponding to the portion of the branch electrode 272 away from the second main electrode 271b. For example, the sum L6+L8 of the width L6 of the portion of the branch electrode 272 near the second main electrode 271b and the width L8 of the slit 273 corresponding to the portion of the branch electrode 272 near the second main electrode 271b is equal to the sum L5+L7 of the width L5 of the portion of the branch electrode 272 away from the second main electrode 271b and the width L7 of the slit 273 corresponding to this portion of the branch electrode 272 away from the second main electrode 271b. By ensuring that the sum of the width of the portion of the branch electrode near the second main electrode and the width of the slit corresponding to the portion of the branch electrode near the second main electrode is equal to the sum of the width of the portion of the branch electrode away from the second main electrode and the width of the slit corresponding to the portion of the branch electrode away from the second main electrode, the width of the branch electrode can be increased while correspondingly reducing the width of the slit between the branch electrodes, or the width of the branch electrode can be decreased while correspondingly increasing the width of the slit between the branch electrodes. This ensures that the space occupied by the pixel electrode remains unchanged, avoiding any impact on the aperture ratio, and allows for different electric field intensities in different regions, thereby achieving different liquid crystal deflection angles in different regions and improving the viewing angle.

In some embodiments, as shown in FIG. 3, the pixel electrode 270 includes a first sub-region 311, a second sub-region 312, a third sub-region 313, and a fourth sub-region 314, which are formed by divisions through the first main electrode 271a and the second main electrode 271b. The branch electrode 272 in the first sub-region 311 extends along the third direction Z1, the branch electrode 272 in the second sub-region 312 extends along the fourth direction Z2, the branch electrode 272 in the third sub-region 313 extends along the fifth direction Z3, and the branch electrode 272 in the fourth sub-region 314 extends along the sixth direction Z4. The angles of the third direction Z1, the fourth direction Z2, the fifth direction Z3, the sixth direction Z4 relative to the first direction X are different (as seen in FIG. 3, the angle between the third direction Z1 and the first direction X is acute, the angle between the fourth direction Z2 and the first direction X is obtuse, the angle between the fifth direction Z3 and the first direction X is greater than 180 degrees but less than 270 degrees, and the angle between the sixth direction Z4 and the first direction X is greater than 270 degrees but less than 360 degrees). In each of the first sub-region 311, the second sub-region 312, the third sub-region 313, and the fourth sub-region 314, in the extending direction of the branch electrode 272 (the extending direction of the branch electrode 272 in the first sub-region 311 is the third direction Z1, and similarly, the extending directions of the branch electrode 272 in the second sub-region 312, the third sub-region 313, and the fourth sub-region 314 are the fourth direction Z2, the fifth direction Z3, and the sixth direction Z4, respectively), the width of the portion of the branch electrode 272 near the connection between the branch electrode 272 and the first main electrode 271a is greater than the width of the portion of the branch electrode 272 away from the connection between the branch electrode 272 and the first main electrode 271a, and the width of the slit 273 corresponding to the portion of the branch electrode 272 near the connection between the branch electrode 272 and the first main electrode 271a is less than the width of the slit 273 corresponding to the portion of the branch electrode 272 away from the connection between the branch electrode 272 and the first main electrode 271a. The width of the portion of the branch electrode 272 near the connection between the branch electrode 272 and the second main electrode 271b is greater than the width of the portion of the branch electrode 272 away from the connection between the branch electrode 272 and the second main electrode 271b, and the width of the slit 273 corresponding to the portion of the branch electrode 272 near the connection between the branch electrode 272 and the second main electrode 271b is less than the width of the slit 273 corresponding to the portion of the branch electrode 272 away from the connection between the branch electrode 272 and the second main electrode 271b.

Specifically, in the first sub-region 311, the second sub-region 312, the third sub-region 313, and the fourth sub-region 314, in the extending direction of the branch electrode 272, along the direction from a position near the connection between the branch electrode 272 and the first main electrode 271a to a position away from the connection between the branch electrode 272 and the first main electrode 271a, at least one portion of the branch electrode 272 has a gradually decreased width; along the direction from a position near the connection between the branch electrode 272 and the second main electrode 271b to a position away from the connection between the branch electrode 272 and the second main electrode 271b, at least one portion of the branch electrode 272 has a gradually decreased width. By the gradually decreased width of at least one portion of the branch electrode in the direction from a position near the connection between the branch electrode and the first main electrode to a position away from the connection between the branch electrode and the first main electrode in the first sub-region, second sub-region, third sub-region, and fourth sub-region, and by the gradually decreased width of at least one portion of the branch electrode in the direction from a position near the connection between the branch electrode and the second main electrode to a position away from the connection between the branch electrode and the second main electrode, in at least one of the first sub-region, second sub-region, third sub-region, and fourth sub-region, it can be provided with regions having different electric field intensities at various positions thereof in at least one of the first sub-region, second sub-region, third sub-region, and fourth sub-region, thereby causing different liquid crystal deflection angles in the region and improving the viewing angle.

Specifically, some branch electrodes will be connected to the first main electrode, while others will be connected to the second main electrode. This arrangement ensures that in the first sub-region, second sub-region, third sub-region, and fourth sub-region, respectively in the third, fourth, fifth, and sixth directions, the width of the portion of the branch electrode near the first main electrode and second main electrode is greater than that of the portion of the branch electrode away from these main electrodes. Additionally, the width of the slit corresponding to the portion of the branch electrode near the first main electrode and second main electrode is smaller than that of the slit corresponding to the portion of the branch electrode away from the first main electrode and second main electrode. This configuration allows for the adjustment of line widths of the branch electrodes to achieve different electric field intensities in different regions, resulting in different liquid crystal deflection angles and an improved viewing angle.

In some embodiments, as shown in FIG. 3, in at least one of the first sub-region 311, second sub-region 312, third sub-region 313, and fourth sub-region 314, the branch electrode 272 has a gradually decreased width along the extending direction of the branch electrode 272, while the slit 273 has a gradually increased width. By the gradually decreased width of the branch electrode and the increased width of the slit, the electric field intensities are different in different regions. In the 4-domain design, in each region, the area near the second main electrode can be considered a primary region, and the area away from the second main electrode can be considered a secondary region. Thus, a display effect similar to an 8-domain system can be achieved by a sub-pixel unit with 4-domain design, thereby improving the viewing angle.

Specifically, the case that the sum of the width of a portion of a branch electrode and the width of corresponding slit is 6 micrometers is considered as an example. In the region near the second main electrode, the slit can have a minimum width of 2 micrometers or less, while one portion of the branch electrode can have a minimum width of 4 micrometers or more. In the region away from the second main electrode, the slit can have a minimum width of 4 micrometers or more, while another portion of the branch electrode can have a minimum width of 2 micrometers or less.

Specifically, in at least two regions out of the first sub-region, second sub-region, third sub-region, and fourth sub-region, or in at least three of these sub-regions, or in each of the first sub-region, second sub-region, third sub-region, and fourth sub-region, the branch electrode has a gradually decreased width in the extending direction of the branch electrode, while the slit has a gradually increased width.

In some embodiments, as illustrated in FIG. 5, at least one portion of branch electrode 272 has a gradually increased width along a direction from a position near the connection between the branch electrodes 272 and the main electrode 271 to a position away from the connection between the branch electrodes 272 and the main electrode 271. By the increased width of at least one portion of the branch electrode along a direction from a position near the connection between the branch electrodes 272 and the main electrode 271 to a position away from the connection between the branch electrodes 272 and the main electrode 271, the electric field intensity varies across this region, so that electric field intensities are different at various positions of the region, leading to different liquid crystal deflection angles in the region, thereby increasing the viewing angle.

In some embodiments, as shown in FIG. 5, the pixel electrode 270 further includes connecting electrodes 274, which are disposed on both sides of the first main electrode 271a. In at least one of the first sub-region 311, the second sub-region 312, the third sub-region 313, and the fourth sub-region 314, in the extending direction of the branch electrode 272, the branch electrode 272 comprises a first portion 272a and a second portion 272b arranged sequentially. The first portion 272a and the second portion 272b are connected, and the second portion 272b is connected to the connecting electrode 274. The first portion 272a has a gradually decreased width in the direction towards the second portion 272b, and the second portion 272b has a gradually decreased width in the direction towards the first portion 272a. By the gradually decreased width of the branch electrode in the direction away from the second main electrode, the branch electrode also has a gradually decreased width in the direction away from the connecting electrode, so that the width of the portion of the branch electrode near the second main electrode and the width of the portion of the branch electrode near the connecting electrode are greater than the width of the portion of the branch electrode between the portion of the branch electrode near the second main electrode and the portion of the branch electrode near the connecting electrode. Consequently, the area where the branch electrode is located can be considered to have two main regions near the second main electrode and near the connecting electrode respectively, and a sub-region located between these two main regions. This arrangement ensures that the areas near the second main electrode and the connecting electrode light up first, followed by the area between them, thereby improving the viewing angle.

Specifically, the slit corresponding to the first portion has a gradually increased width in the direction towards the second portion, and the slit corresponding to the second portion has a gradually increased width in the direction towards the first portion.

Specifically, it can be understood that in at least two regions out of the first sub-region, second sub-region, third sub-region, and fourth sub-region, or in at least three of these sub-regions, or in each of the first sub-region, second sub-region, third sub-region, and fourth sub-region, the branch electrode includes a first portion and a second portion arranged sequentially along the extending direction of the branch electrode. The first portion and the second portion are connected, with the second portion connecting to the connecting electrode. The first portion has a gradually decreased width in the direction towards the second portion, and the second portion has a gradually decreased width in the direction towards the first portion.

Specifically, the first portion and the second portion may be symmetrically about a central axis arranged.

Specifically, it can be understood that the first portion and the second portion are actually two portions of the branching electrode, and there is no clear boundary between them. The line where the branching electrode is the narrowest can be considered the boundary between the two portions. Accordingly, the width of the part in the first portion near the second main electrode is greater than the width of the part in the first portion away from the second main electrode. The width of the part in the second portion near the connecting electrode is greater than the width of the part in the second portion away from the connecting electrode. The part in the first portion near the second main electrode can be considered the main region, and the part in the second portion near the connecting electrode can also be considered the main region. The part in the first portion away from the second main electrode and the part in second portion away from the connecting electrode can be considered secondary region, thereby increasing the viewing angle.

In some embodiments, as illustrated in FIG. 6, in at least one of the first sub-region 311, the second sub-region 312, the third sub-region 313, and the fourth sub-region 314, the branch electrode 272 comprises multiple branch portions 272c. In each of these branch portions 272c, the branch portion 272c has a gradually decreased width in the extending direction of the branch electrode 272, while the slit 273 between the branch portions 272c has a gradually increased width. By dividing the branch electrode into multiple branch portions with a gradually decreased width and by the gradually increased width of the slits between branch portions, the number of partitions can be further increased. This results in a greater number of different liquid crystal deflection angles, thereby increasing the viewing angle further.

Specifically, each of the branch portions can be identical.

Specifically, each branch portion can be arranged to have a gradually decreased width in the direction away from the second main electrode.

More specifically, the branch electrode can include multiple branch portions extending in at least two, at least three, or all of the following directions: the third, fourth, fifth, and sixth directions. In each branch portion, the branch portion has a gradually decreased width, while the slit between branch portions has a gradually increased width.

In some embodiments, in at least one of the first sub-region 311, the second sub-region 312, the third sub-region 313, and the fourth sub-region 314, the branch electrode 272 includes multiple portions. At least two portions have a consistent width throughout respectively, but the width of one of the portions is different from the width of another of the portions. When configuring the branch electrode, some portions may have a gradually decreased width, while other portions may have a consistent width. The unequal widths among different portions result in different electric field intensities, causing different liquid crystal deflection angles at various positions in the region, thereby increasing the viewing angle.

In some embodiments, in at least one of the first sub-region 311, the second sub-region 312, the third sub-region 313, and the fourth sub-region 314, the branch electrode 272 includes multiple portions. Each portion has a consistent width throughout, but the width of one of the portions is different from the width of another of the portions. By ensuring that the width remains consistent in each portion while varying the width among different portions, different deflection angles of the liquid crystals in various regions can be achieved, thereby increasing the viewing angle.

Specifically, in the aforementioned embodiments, for explanatory purposes, the branch electrode has a gradually decreased width; the branch electrode is divided into two portions, with the two portions having a gradually decreased width respectively in a direction towards each other; and each of the portions has a gradually decreased width. However, the embodiments of the present application are not limited to this configuration. The width of one of the portions can be different from the width of another of the portions, but each portion has a consistent width throughout.

In some embodiments, as illustrated in FIG. 7(a) and FIG. 7(c), the gate electrode layer 22 comprises a scanning line 221, a gate electrode 222, a first electrode 223, a second electrode 224, and a third electrode 225. The pixel electrode layer 27 further includes a fourth electrode 275. The scanning line 221 is arranged along the second direction Y, the gate electrode 222 is connected to the scanning line 221, the first electrode 223 is disposed corresponding to the source-drain electrode layer 25, the second electrode 224 is disposed corresponding to the first main electrode 271a, and the third electrode 225 is disposed corresponding to the fourth electrode 275. By providing the first electrode, second electrode, and third electrode in the gate electrode layer and providing the fourth electrode in the pixel electrode layer, a storage capacitor can be formed by the third electrode, second electrode, and third electrode as well as the electrodes of the source-drain electrode layer and the pixel electrode layer.

Specifically, as shown in FIG. 7(b), the source-drain layer 25 includes a data line 251, a source electrode 252, and a drain electrode 253. The drain electrode 253 is disposed corresponding to the first electrode and is connected to the pixel electrode.

Specifically, FIG. 7 presents an exploded view of each film layer of the array substrate shown in FIG. 3. It is understood that in other embodiments, the exploded view of each film layer of the array substrate can be adaptively modified with reference to FIG. 7, and details are omitted here.

Specifically, as shown in FIG. 2, the array substrate 2 further includes a gate electrode layer 23, an active layer 24, and an interlayer insulating layer 26.

Specifically, in FIG. 2, the thin film transistor (TFT) on the array substrate is exemplified as thin film transistor having a bottom-gate structure and a top-contact structure. However, the embodiments of the present application are not limited to this, and the thin film transistor can have a top-gate structure, and a bottom-contact structure.

Specifically, in an embodiments of the present application, the array substrate is illustrated using a tri-gate design as an example, where a pixel unit is driven by three scanning lines to reduce the number of data lines. However, the embodiments of the present application are not limited to this; the array substrate can be adopted a design where one-pixel unit is driven by one scanning line and three data lines, or the array substrate can have other architectures.

Specifically, the aforementioned embodiments provide a detailed explanation of the array substrate, focusing on the specific design of each film layer and the relationships between the various film layers. It should be understood that where there is no conflict among the embodiments, they can be combined. For example, in at least one of the third direction, fourth direction, fifth direction, and sixth direction, the branch electrode has a gradually decreased width, and the slit has a gradually increased width. Moreover, in at least one of the third direction, fourth direction, fifth direction, and sixth direction, the branch electrode includes multiple branch portions, where each branch portion has a gradually deceased width, and the slit between branch portions has a gradually increased width.

Additionally, the embodiments of the present application provide a display panel that includes the array substrate as described in any of the aforementioned embodiments.

In the described embodiments, the focus of each embodiment varies. For parts not detailed in a particular embodiment, refer to the relevant descriptions in other embodiments.

The above provides a detailed introduction to an array substrate and a display panel as provided in the embodiments of the present application. Specific examples are used to illustrate the principles and implementation methods of the present application. The descriptions of the above embodiments are merely to aid in understanding the technical solutions and core ideas of the present application. Those skilled in the art should understand that they can still make modifications to the technical solutions described in the aforementioned embodiments or make equivalent replacements for some of the technical features. An essence of technical solutions corresponding to these modifications or replacements do not depart from the scope of technical solutions of embodiments in the present application.

What is claimed is:

1. An array substrate, comprising:
a substrate;
a gate electrode layer disposed on a side of the substrate;
a source-drain electrode layer disposed on a side of the gate electrode layer away from the substrate; and
a pixel electrode layer disposed on a side of the source-drain electrode layer away from the gate electrode layer, wherein the pixel electrode layer comprises a pixel electrode, which comprises a main electrode, branch electrodes, and slits, and the main electrode comprises a first main electrode aligned along a first direction and a second main electrode aligned along a second direction;
wherein at least one portion of the branch electrodes has a gradually decreased width along a direction from a position near a connection between the branch electrodes and the main electrodes to a position away from the connection between the branch electrodes and the main electrodes.

2. The array substrate according to claim 1, wherein the pixel electrode comprises a first sub-region, a second sub-region, a third sub-region, and a fourth sub-region formed by divisions through the first main electrode and the second main electrode, the branch electrodes in the first sub-region extend along a third direction, the branch electrodes in the second sub-region extend along a fourth direction, the branch electrodes in the third sub-region extend along a fifth direction, the branch electrodes in the fourth sub-region extend along a sixth direction, and angles of the third direction, the fourth direction, the fifth direction, and the sixth direction relative to the first direction are different;
wherein at least one position of the branch electrodes has a gradually decreased width from a position near a connection between the branch electrodes and the first main electrode to a position away from the connection between the branch electrodes and the first main electrode along an extending direction of the branch electrodes in the first sub-region, the second sub-region, the third sub-region, and the fourth sub-region; and
wherein at least one position of the branch electrodes has a gradually decreased width from a position near a connection between the branch electrodes and the second main electrode to a position away from the connection between the branch electrodes and the second main electrode.

3. The array substrate according to claim 2, wherein the branch electrode has a gradually decreased width along the extending direction of the branch electrode in at least one of the first sub-region, the second sub-region, the third sub-region, and the fourth sub-region.

4. The array substrate according to claim 2, wherein at least one portion of the branch electrodes has a gradually increased width in a direction from a position near the connection between the branch electrodes and the main electrode to a position away from the connection between the branch electrodes and the main electrode.

5. The array substrate according to claim 4, wherein the pixel electrode further comprises connecting electrodes, which are disposed on both sides of the first main electrode, the branch electrode comprises a first portion and a second portion arranged sequentially along the extending direction of the branch electrode in at least one of the first sub-region, the second sub-region, the third sub-region, and the fourth sub-region, the first portion and the second portion are connected, with the second portion being connected to the connecting electrode, the first portion has a gradually decreased width in a direction toward the second portion, and the second portion has a gradually decreased width in a direction toward the first portion.

6. The array substrate according to claim 2, wherein the branch electrode in at least one of the first sub-region, the second sub-region, the third sub-region, and the fourth sub-region comprises multiple branch portions, and in each of the branch portions the branch portion has a gradually decreased width along the extending direction of the branch electrode.

7. The array substrate according to claim 2, wherein the branch electrode in at least one of the first sub-region, the second sub-region, the third sub-region, and the fourth sub-region comprises multiple portions, and at least two portions have a consistent width throughout respectively, but the width of one of the portions is different from the width of another of the portions.

8. The array substrate according to claim 1, wherein a sum of a width of a portion of the branch electrode near the second main electrode and a width of a slit corresponding to the portion of the branch electrode near the second main electrode is equal to a sum of a width of a portion of the branch electrode away from the second main electrode and a width of a slit corresponding to the portion of the branch electrode away from the second main electrode.

9. The array substrate according to claim 1, wherein the gate electrode layer comprises scanning lines, gate electrodes, a first electrode, a second electrode, and a third electrode, the pixel electrode layer further comprises a fourth electrode, the scanning lines are arranged along the second direction, the gate electrodes are connected to the scanning lines, the first electrode is disposed corresponding to the source-drain electrode layer, the second electrode is disposed corresponding to the first main electrode, and the third electrode is disposed corresponding to the fourth electrode.

10. A display panel, comprising an array substrate, the array substrate comprising:
a substrate;
a gate electrode layer disposed on a side of the substrate;
a source-drain electrode layer disposed on a side of the gate electrode layer away from the substrate; and
a pixel electrode layer disposed on a side of the source-drain electrode layer away from the gate electrode layer, wherein the pixel electrode layer comprises a pixel electrode, which comprises a main electrode, branch electrodes, and slits, and the main electrode comprises a first main electrode aligned along a first direction and a second main electrode aligned along a second direction;
wherein at least one portion of the branch electrodes has a gradually decreased width along a direction from a position near a connection between the branch electrodes and the main electrodes to a position away from the connection between the branch electrodes and the main electrodes.
